(19) United States
(12) Patent Application Publication
(10) Pub. No.: US 2025/0197023 A1
(43) Pub. Date: Jun. 19, 2025

(54) VIBRATION ISOLATOR WITH TRANSLATION COMPLIANCE

(71) Applicant: Raytheon Company, Tewksbury, MA (US)

(72) Inventor: Eric E-Lee Chang, Dallas, TX (US)

(21) Appl. No.: 18/958,626

(22) Filed: Nov. 25, 2024

Related U.S. Application Data
(60) Provisional application No. 63/609,533, filed on Dec. 13, 2023.

(51) Int. Cl. B64D 47/08; F16F 15/073; F16M 11/12

(52) U.S. Cl. CPC B64D 47/08; F16F 15/073; F16M 11/123

(57) ABSTRACT

A base isolator for vibration isolation mounting of equipment, includes a pair of rigid (or relatively rigid) tubes, a flexible tube with slots between beams, and a pair of slitted plates. The rigid tubes and the flexible tube may be concentric. The slitted plates couple together ends of the tubes and provide vertical (axial) translational compliance. The flexible tube, which is outside or within the rigid tubes, provides horizontal translational compliance in directions perpendicular to an axis of the isolator. The base isolator, while providing compliance in all three translational directions, provides rotational stiffness, such as for rotational torques about the axis, and more generally for pitch and roll directions.

### CROSS-REFERENCE TO RELATED APPLICATIONS

This application claims the benefit of U.S. Patent Application Ser. No. 63/609,533, filed Dec. 13, 2023, the disclosure of which is incorporated herein by reference in its entirety.

### FIELD

The disclosure is in the field of vibration isolation systems for mounting of devices.

### BACKGROUND

Sensor turrets have an azimuth and elevation gimbal that has torquers that need stiffness to react against. At the same time, it may be desirable to have translational compliance to isolate high frequency vibration which if passed through to the optical system may cause image blur.

### SUMMARY

A base isolator provides translational compliance and rotational stiffness.

According to an aspect of the disclosure, a base isolator for providing vibration isolation, the base isolator including: an inner mount; an outer mount; and an isolation arrangement between the inner mount and the outer mount, the isolation arrangement including: an inner tube with an axis; an outer tube surrounding the inner tube; a top plate and a bottom plate connecting the inner tube and the outer tube, the top plate and the bottom plate having a series of slits therein; and a flexible tube, coupled to the inner tube and the outer tube, that includes a series of parallel bending beams separated by slots; wherein the top plate and the bottom plate preferentially deform under axial translation loads in an axial direction that is parallel to the axis; and wherein the flexible tube preferentially deforms under translational loads in horizontal directions perpendicular to the axis.

According to an embodiment of any paragraph(s) of this summary, the top plate is substantially parallel to, or is parallel to, the bottom plate.

According to an embodiment of any paragraph(s) of this summary, the isolation arrangement provides rotational stiffness, with a natural frequency of rotational deformation modes that is greater than a natural frequency of translational deformation modes.

According to an embodiment of any paragraph(s) of this summary, he bending beams and the slots are oriented in the axial direction.

According to an embodiment of any paragraph(s) of this summary, the inner mount includes an inner flange.

According to an embodiment of any paragraph(s) of this summary, the outer mount includes an outer flange.

According to an embodiment of any paragraph(s) of this summary, the flexible tube is radially outward of the inner tube and the outer tube.

According to an embodiment of any paragraph(s) of this summary, the flexible tube is radially inward of the inner tube and the outer tube.

According to an embodiment of any paragraph(s) of this summary, at least one of the mounts is at a top or a bottom of the base isolator.

According to an embodiment of any paragraph(s) of this summary, at least one of the mounts is between a top and a bottom of the base isolator.

According to an embodiment of any paragraph(s) of this summary, the slits are oriented at a nonzero angle offset from a radial direction.

According to an embodiment of any paragraph(s) of this summary, the nonzero angle ranges from 5 to 60 degrees offset from the radial direction.

According to an embodiment of any paragraph(s) of this summary, the nonzero angle ranges from 10 to 40 degrees offset from the radial direction.

According to an embodiment of any paragraph(s) of this summary, the nonzero angle ranges from 10 to 20 degrees offset from the radial direction.

According to an embodiment of any paragraph(s) of this summary, the slits in the top plate are offset in an opposite direction from the slits in the bottom plate.

According to an embodiment of any paragraph(s) of this summary, the top late is an annular top plate, and the bottom plate is an annular bottom plate.

According to an embodiment of any paragraph(s) of this summary, each of the plates has at least 4 slits.

According to an embodiment of any paragraph(s) of this summary, the slits are evenly circumferentially spaced around each of the top plate and the bottom plate.

According to an embodiment of any paragraph(s) of this summary, the flexible tube has at least 4 slots.

According to an embodiment of any paragraph(s) of this summary, the beams are evenly circumferentially spaced around the flexible tube.

According to an embodiment of any paragraph(s) of this summary, the beams are axially between rigid portions of the flexible tube.

According to an embodiment of any paragraph(s) of this summary, the base isolator is in combination a sensor turret connected to one of the mounts.

According to an embodiment of any paragraph(s) of this summary, the sensor turret is a multi-spectral targeting system.

According to an embodiment of any paragraph(s) of this summary, the mount that is not connected to the sensor turret is configured for connection to a vehicle.

According to an embodiment of any paragraph(s) of this summary, the beams of the flexible tube are tapered beams.

According to an embodiment of any paragraph(s) of this summary, the tapered beams are widest (circumferentially) at their supported tops and bottoms, and narrowest in their middles.

According to an embodiment of any paragraph(s) of this summary, the inner tube has relatively rigid flexure beams, that allow some rotational flexure.

According to an embodiment of any paragraph(s) of this summary, the rotational flexure of the inner tube may be used to compensate for (relieve) rotational stresses caused by vertical movements (movements in the axial direction) of the top and bottom plates.

A method of providing preferential compliance in a mount, the method including the steps of: coupling a sensor turret to a base isolator; providing vertical compliance through slitted plates of the base isolator; and providing horizontal compliance through a slotted flexible tube of the base isolator.

While a number of features are described herein with respect to embodiments of the disclosure; features described with respect to a given embodiment also may be employed in connection with other embodiments. The following description and the annexed drawings set forth certain illustrative embodiments of the disclosure. These embodiments are indicative, however, of but a few of the various ways in which the principles of the disclosure may be employed. Other objects, advantages, and novel features according to aspects of the disclosure will become apparent from the following detailed description when considered in conjunction with the drawings.

### BRIEF DESCRIPTION OF THE DRAWINGS

The annexed drawings, which are not necessarily to scale, show various aspects of the disclosure.

FIG. 1A is an oblique view of a base isolator according to an embodiment, for mounting a turret device.

FIG. 1B is an oblique view of the turret device of FIG. 1A, mounted to an air vehicle (a drone).

FIG. 2A is an oblique view of the base isolator of FIG. 1A.

FIG. 2B is another oblique view of the base isolator of FIG. 1A.

FIG. 3 is a detailed cutaway view of part of the base isolator of FIG. 1A.

FIG. 4 is a detailed cutaway view of another part of the base isolator of FIG. 1A.

FIG. 5 shows a vertical translation mode in the base isolator of FIG. 1A.

FIG. 6 shows a first horizontal translation mode in the base isolator of FIG. 1A.

FIG. 7 shows a second horizontal translation mode in the base isolator of FIG. 1A.

FIG. 8 shows a rotational mode in the base isolator of FIG. 1A.

FIG. 9 is a high-level flow chart of a method according to an embodiment.

FIG. 10 is an oblique view of a base isolator according to another embodiment.

FIG. 11 is an oblique view of a flexible tube of the base isolator of FIG. 10.

FIG. 12 is a magnified view of a portion of the flexible tube of FIG. 11.

FIG. 13 is an oblique view of an inner tube of the base isolator of FIG. 10.

FIG. 14 is a cutaway side view of the inner tube of FIG. 13.

FIG. 15 is a magnified view of a portion of the inner tube of FIG. 13.

### DETAILED DESCRIPTION

A base isolator for vibration isolation mounting of equipment, includes a pair of rigid (or relatively rigid) tubes, a flexible tube with slots between beams, and a pair of slitted plates. The rigid tubes and the flexible tube may be concentric. The slitted plates couple together ends of the tubes and provide vertical (axial) translational compliance. The flexible tube, which is outside or within the rigid tubes, provides horizontal translational compliance in directions perpendicular to an axis of the isolator. The base isolator, while providing compliance in all three translational directions, provides rotational stiffness, such as for rotational torques about the axis, and more generally for pitch and roll directions.

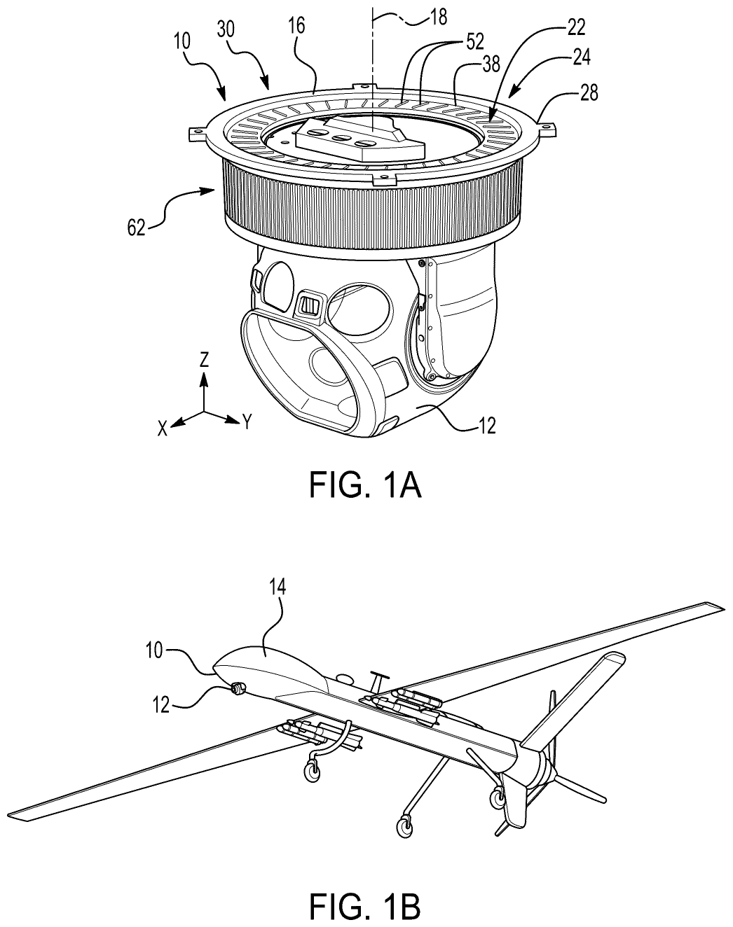

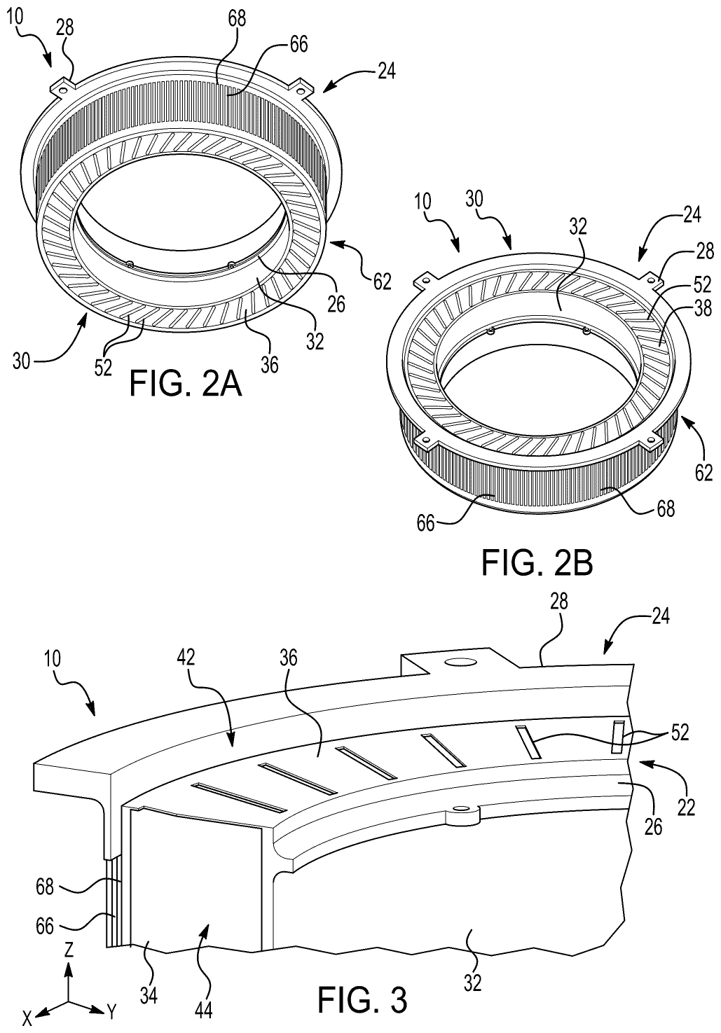

Referring initially to FIGS. 1A-2B, a base isolator 10 is used for mounting equipment, such as a turret 12. The isolator 10 mounts the turret 12 to another device or structure, for example a vehicle 14 such as an air vehicle (a drone in the illustrated embodiment). The turret 12 is mounted in a central opening 16 of the isolator 10 that defines an axis 18.

In one embodiment the turret 12 may be a multi-spectral targeting system (MTS) that is a turreted electro-optical and infrared sensor used in maritime and overland intelligence, surveillance, and reconnaissance missions. The MTS may combine electro-optical/infrared (EO/IR), laser designation, and laser illumination capabilities in a single sensor package. One characteristic of such turrets is that they have a cantilevered center of gravity, away from a base where they are mounted to an object such as a vehicle. Such turret systems have been used in various types of aerial vehicles, including both unmanned and crewed air vehicles of various sorts. This is only one example of the sort of device that may be coupled to the isolator 10, for isolation from forces. Many other devices are possible.

Other sensors may be used as part of systems including the isolator 10. Non-limiting examples of other sensors include radar systems, and lidar systems. More broadly, the isolator 10 may be used with any sort of gimbaled system, such as laser communication systems or mechanically-steered systems.

The isolator 10 has an inner mount 22 and an outer mount 24, that include respective inner and outer mounting flanges 26 and 28. The turret 12 is mounted to the inner flange 26, and the outer flange 28 is mounted to the host structure/device/vehicle. Other sorts of mountings than flanges alternatively may be employed.

As explained in greater detail, the isolator 10 includes an isolation arrangement 30 between the inner mount 22 and the outer mount 24. The isolation arrangement 30 provides a response to forces. In the illustrated embodiment the isolator 10 is configured to have vibration isolation in all translation directions, while providing rotational rigidity, such as in pitch and roll directions. The rotational rigidity may be advantageous in combination with the turret 12, which may use azimuthal and elevation torquers that benefit from stiffness to “push against” during operation.

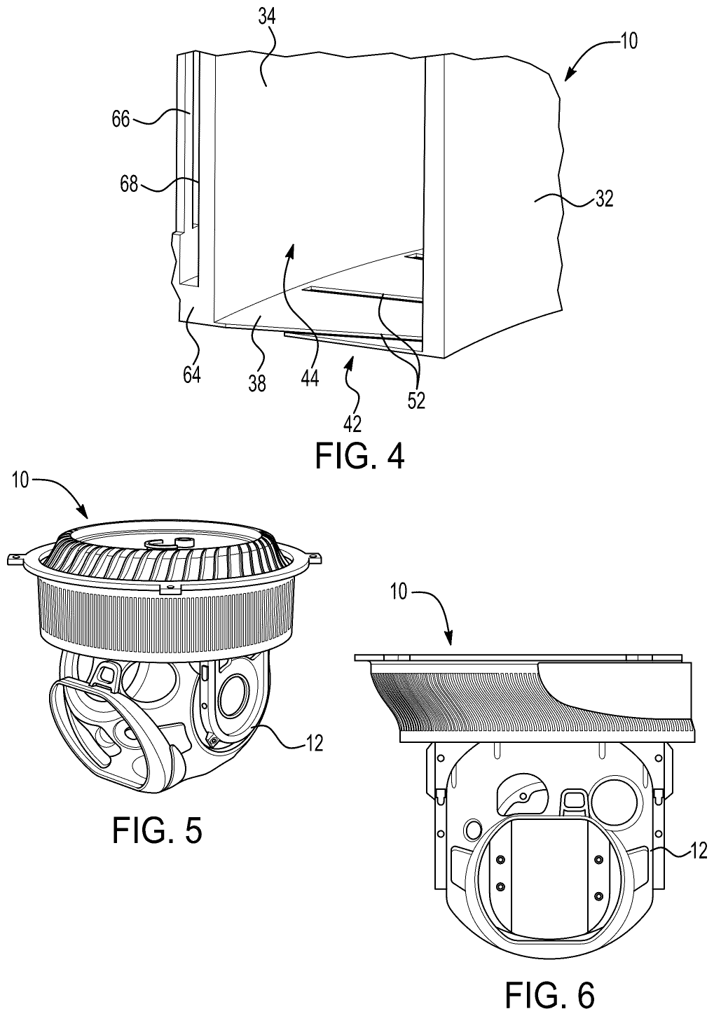

With reference in addition to FIGS. 3 and 4, details of an embodiment of the isolation arrangement 30 are now given. The arrangement 30 includes an inner tube 32, and an outer tube 34 that surrounds the inner tube 32. The outer tube 34 is shown in FIG. 3, but is hidden from view in FIGS. 2A and 2B. The tubes 32 and 34 are rigid tubes and are connected to each other at opposite (top and bottom) ends by a top plate 36 and a bottom plate 38. The plates 36 and 38 may be annular plates. The plates 36 and 38 may be substantially parallel to, or may be parallel to, one another. The tubes 32 and 34, and the plates 36 and 38, together form an annular box structure 42 that surrounds and defines an enclosed annular space 44. The tubes 32/34 and the plates 36/38 form a rectangular cross-section box around the annular space 44.

The plates 36 and 38 are thinner than the tubes 32 and 34, with the plates 36 and 38 configured to flex in the vertical (axial), to allow relative vertical movement between the tubes 32 and 34. To facilitate that flexing, the plates 36 and 38 each have a series of slits 52 in them. The slits 52 are circumferentially spaced around the plates 36 and 38, for example being evenly circumferentially spaced all the way around each of the plates 36 and 38. The circumferentially (tangentially) spaced slits 52 reduce the stiffness non-linearity of the structure. The slits 52 thus may separate a series of substantially identical portions of the plates 36 and 38. This facilitates symmetry in the flexing of the plate 36 and 38, avoiding asymmetric forces.

The slits 52 may be angled offset from a radial direction. In an embodiment the slits 52 may be angled about 15 degrees from the radial direction. More broadly, the slits may be angled from 10 to 20 degrees from the radial direction, from 5 to 25 (or 30) degrees, from 10 to 40 degrees, or from 5 to 60 degrees from the radial direction. These are only example values, and other angles and ranges of angles may be used.

All of the slits 52 in each of the plates 36 or 38 may be angled in the same direction from the radial direction. The slits 52 of the top plate 36 may be angled in the opposite direction from the slits 52 in the bottom plate 38. This allows small rotations of the plates 36 and 38 during flexure to cancel each other out.

In the illustrated embodiment each of the plates 36 and 38 has 40 of the slits 52. More or fewer slits may be used in other embodiments.

The box structure 42 serves as a vertical vibration isolation subassembly. The slitted plates 36 and 38 allow for the tubes 32 and 34 to translate vertically (axially), while providing rotational stiffness.

A flexible tube 62 is radially outward from the annular box structure 42, with a rigid radial extension 64 at a bottom of the outer tube 34. The tube 62 includes a series of beams 66 separated by intervening slots 68. The beams 66 are oriented in the axial direction. The beams 66 may be substantially identical to one another and may be evenly spaced circumferentially around the flexible tube 62. The beams 66 may each have a rectangular cross-sectional shape.

The beams 66 will bend to allow for horizontal compliance while maintaining rotational stiffness when the moment loads go through the lengths of the beams 66. The width of each of the beams 66 may be the same (or about the same) as the width of each of the slots 68. Alternatively, the beams 66 may be wider than the slots 68, or the slots 68 may be wider than the beams 66.

The inner flange 26 is mounted on the inner tube 32, extending inward from the inner tube 32. The inner flange 26 is shown in the figures as near the top of the inner tube 32, but alternatively the inner flange 26 may be mounted any of a variety of different axial locations on the inner tube 32, such as, at an axial middle (or central portion) of the inner tube 32 (as shown in FIGS. 2A and 2B). It may be advantageous to place the inner flange 26 at (or near) a middle (axially) of the inner tube 32, so as to provide more balanced loads.

The outer flange 28 is mounted at a top of the flexible tube 62, extending outward from the flexible tube 62. The outer flange 28 and the extension 64 are at opposite sides of the flexible tube 62, with both the outer flange 28 and the extension outside (radially above and below) the beams 66 and the slots 68. The beams 66 are thus axially between rigid portions of the flexible tube 62.

The parts of the base isolator 10 may be made by any of a variety of suitable materials. Examples of suitable materials include aluminum and steel.

The illustrated embodiment is but one possible arrangement of components, and many other alternative arrangements are possible. For example, alternatively the flexible tube may be placed radially inward of the inner and outer rigid tubes.

The mounting device that includes the base isolator 10 may have other features. For example, snubbers may be employed to limit travel of parts of the isolator in certain directions, and/or during operations (such as vehicle maneuvers), where device operation (such as operation of sensor that is part of the turret 12) is not desired or not required. In the vertical isolation subassembly, the box structure 42 between that includes the tubes 32 and 34 and the plates 36 and 38, a very soft spring can provide the gravity relief support of the weight of the turret 12.

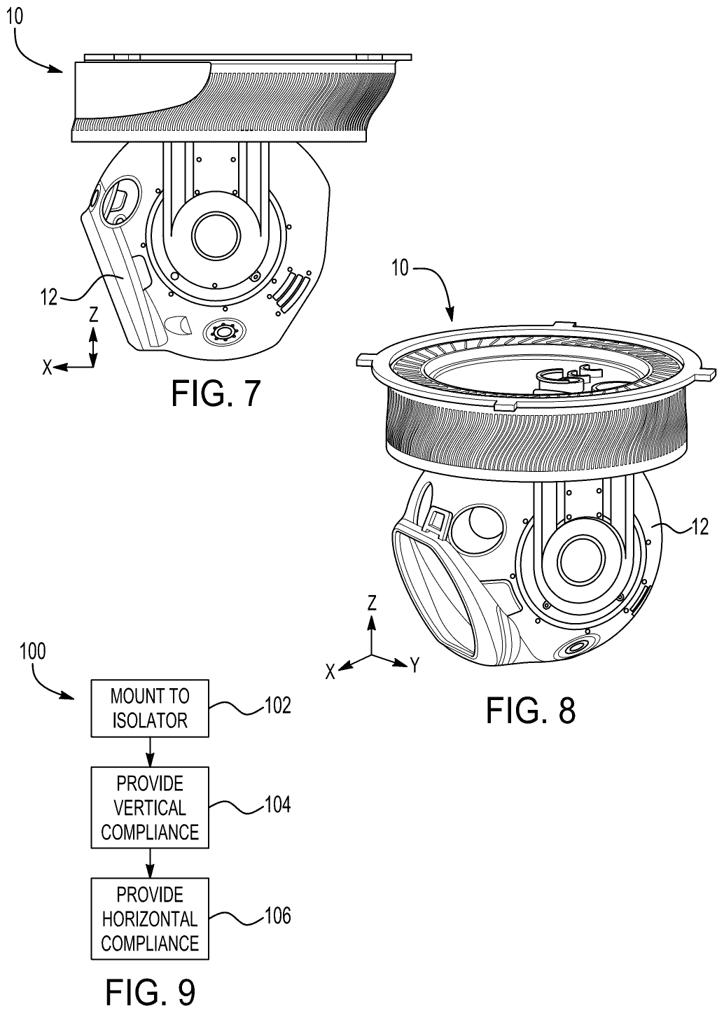

FIGS. 5-7 show response of the base isolator 10 in all three translation modes. The base isolator 10 provides compliance in the translation directions, providing vibration isolation to the turret 12 from translations. In an example embodiment the natural frequency of the base isolator 10 in these modes may be around 10 Hz, for example within 10% or 20% of 10 Hz. The vertical translation mode (FIG. 5) is decoupled from the horizontal translation modes (FIGS. 6 and 7).

FIG. 8 shows response of the base isolator 10 in a vertical (axial) torsion mode, to torsional forces around an axis of the turret 12. The natural frequency is much higher in this mode than in the translation modes illustrated in FIGS. 5-7. In an example embodiment the natural frequency of the base isolator 10 in this mode may be around 25 Hz, for example within 10% or 20% of 25 Hz.

The base isolator 10 advantageously provides a compact arrangement that allows a device such as the turret 12 to nest inside of the base isolator 10. This has an advantage, for example, of not requiring any additional vertical space (space in the axial direction) for the mounting. For example, using the base isolator 10 may support implementations in which a device such as the turret 12 may nest inside the base isolator 10, without providing additional vertical space (space in the axial direction) for the mounting.

FIG. 9 is a high-level flow chart of a method 100 of using the base isolator 10 (FIG. 1A) to provide translation isolation to a device such as the turret 12 (FIG. 1A). In step 102 the turret 12 is mounted to the isolator 10. In step 104 the box structure 42 (FIG. 3), and particularly the slitted plates 36 and 38 (FIG. 3), provides vertical translation isolation to the turret 12. In step 106 the slotted flexible tube 62 (FIG. 1) provides horizontal translation isolation.

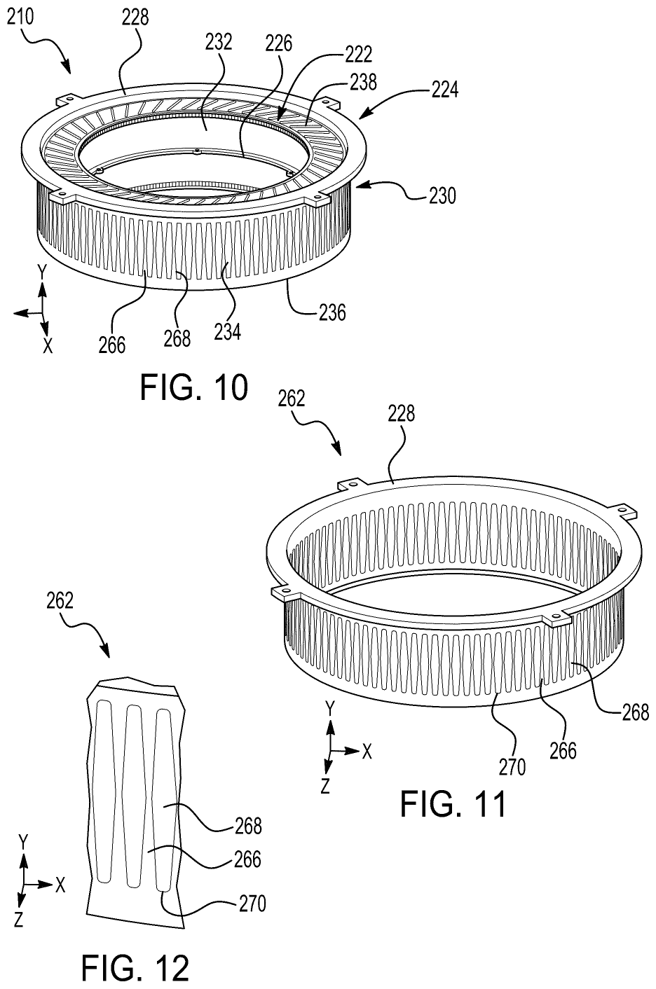

FIGS. 10-15 shown another embodiment, a base isolator 210. Like the isolator 10 (FIG. 1A), the base isolator 210 an inner mount 222 and an outer mount 224, that include respective inner and outer mounting flanges 226 and 228. The isolator 210 also includes an isolation arrangement 230 between the inner mount 222 and the outer mount 224. The isolation arrangement 230 functions similarly to the isolation arrangement 30 (FIG. 2A), and discussion of many common features of the base isolators 10 and 210 will be omitted below for brevity.

The arrangement 230 includes an inner tube 232, and an outer tube 234 that surrounds the inner tube 232. The tubes 232 and 234 are rigid tubes, or more rigid tubes, in that they are more rigid than a flexible tube 262 that is discussed further below. The tubes 232 and 234 are connected to each other at opposite (top and bottom) ends by a top plate 236 and a bottom plate 238. The plates 236 and 238 may be similar in configuration to the plates 36 and 38 (FIGS. 2A and 2B) of the isolator 10 (FIG. 1A). Thus the plates 236 and 238 may each have a series of slits 252 in them.

The flexible tube 262 is radially outward from an annular box structure 242 bounded by the tubes 232 and 234, and the plates 236 and 238. The tube 262 includes a series of beams 266 separated by intervening slots 268. The beams 266 and the slots 268 are oriented in the axial direction.

With reference in particular to FIGS. 11 and 12, the beams 266 and the slots 268 have nonuniform width (extent in the circumferential direction), with the width changing in the axial direction. The beams 266 are cantilevered tapered beams, widest at their top and bottom ends, and narrowest in the middle, midway between the top and bottom ends. The width changes in the slots 268 are the reverses-widest in their centers and tapering narrower as they approach the top and bottom ends.

This tapered configuration of the beams 266 reduces stress at the ends (top and bottom) of the beams 266. In addition, the beams 266 and slots 268 have radii at the top and bottom of the beams 266, indicated by reference number 270. These radii 270 reduce stress concentration at the ends (top and bottom) of the beams 266. For each of the beams 266, the cross-section may be rectangular, with a long extent in the circumferential direction, and with a short extent in the radial direction.

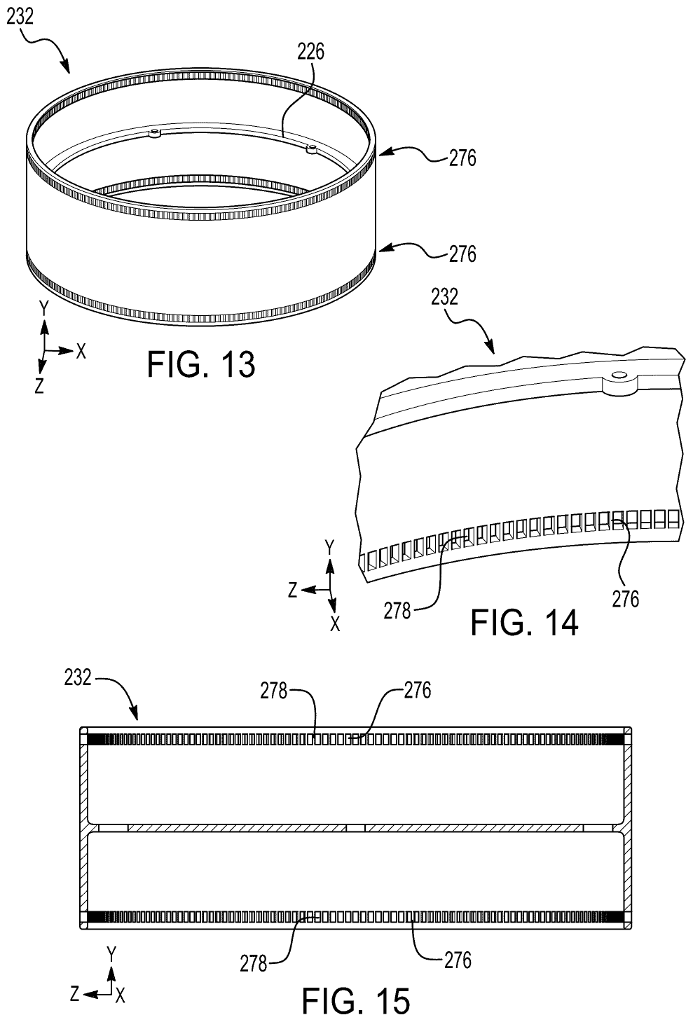

Turning now to FIGS. 13-15, the inner (relatively) rigid tube 232 has series of top and bottom radial flexures 276, with slots 278 between pairs of the flexures 276. The inner tube 232 is rigid in a relative sense, being more rigid than the flexible 262, without being fully rigid. The inner rigid tube 232 may be less rigid than the outer rigid tube 234, due to the present of the flexures 276 and the slots 278.

The flexures 276 extend in the axial direction, and may each extend less than 10%, or less than 5%, of an extent of the inner tube 232 in the axial direction. The flexures 276 may be circumferentially evenly spaced around the inner tube 232. The flexures 276 are short and very rigid in comparison to the beams (flexures) 266 of the flexible 262. The purpose of the top and bottom flexures 276 is to allow the very top and very bottom of these flexures 276 to slightly rotate, for example to relieve rotational stresses when plates 236 and 238 displace vertically.

Although the disclosure has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

What is claimed is:

1. A base isolator for providing vibration isolation, the base isolator comprising:
an inner mount;
an outer mount; and
an isolation arrangement between the inner mount and the outer mount, the isolation arrangement including:
an inner tube with an axis;
an outer tube surrounding the inner tube;
a top plate and a bottom plate connecting the inner tube and the outer tube, the top plate and the bottom plate having a series of slits therein; and
a flexible tube, coupled to the inner tube and the outer tube, that includes a series of parallel bending beams separated by slots;
wherein the top plate and the bottom plate preferentially deform under axial translation loads in an axial direction that is parallel to the axis; and
wherein the flexible tube preferentially deforms under translational loads in horizontal directions perpendicular to the axis.

2. The base isolator of claim 1, wherein the isolation arrangement provides rotational stiffness, with a natural frequency of rotational deformation modes that is greater than a natural frequency of translational deformation modes.

3. The base isolator of claim 1, wherein the bending beams and the slots are oriented in the axial direction.

4. The base isolator of claim 1, wherein the inner mount includes an inner flange.

5. The base isolator of claim 1, wherein the outer mount includes an outer flange.

6. The base isolator of claim 1, wherein the flexible tube is radially outward of the inner tube and the outer tube.

7. The base isolator of claim 1, wherein the flexible tube is radially inward of the inner tube and the outer tube.

8. The base isolator of claim 1, wherein at least one of the mounts is at a top or a bottom of the base isolator.

9. The base isolator of claim 1, wherein at least one of the mounts is between a top and a bottom of the base isolator.

10. The base isolator of claim 1, wherein the slits are oriented at a nonzero angle offset from a radial direction.

11. The base isolator of claim 10, wherein the nonzero angle ranges from 5 to 60 degrees offset from the radial direction.

12. The base isolator of claim 10, wherein the slits in the top plate are offset in an opposite direction from the slits in the bottom plate.

13. The base isolator of claim 1, wherein each of the plates has at least 4 slits.

14. The base isolator of claim 1, wherein the slits are evenly circumferentially spaced around each of the top plate and the bottom plate.

15. The base isolator of claim 1, wherein the flexible tube has at least 4 slots.

16. The base isolator of claim 1, wherein the beams are evenly circumferentially spaced around the flexible tube.

17. The base isolator of claim 1, wherein the beams are axially between rigid portions of the flexible tube.

18. The base isolator of claim 1,
in combination with a sensor turret connected to one of the mounts;
wherein the sensor turret is a multi-spectral targeting system; and
wherein the mount that is not connected to the sensor turret is configured for connection to a vehicle.

19. A method of providing preferential compliance in a mount, the method comprising:
coupling a sensor turret to a base isolator;
providing vertical compliance through slitted plates of the base isolator; and
providing horizontal compliance through a slotted flexible tube of the base isolator.
